(19) United States
(12) Patent Application Publication
(10) Pub. No.: US 2025/0107637 A1
(43) Pub. Date: Apr. 3, 2025

(54) PORTABLE INFLATABLE MATTRESS

(71) Applicant: Comfetravel LLC, St. Thomas, VI (US)

(72) Inventor: Lori-Ann Ravalier, St. Thomas, VI (US)

(21) Appl. No.: 18/479,189

(22) Filed: Oct. 2, 2023

(51) Int. Cl. A47C 27/08; A47G 9/10; B32B 5/02; B32B 27/12; B32B 27/40

(52) U.S. Cl. CPC A47C 27/082; A47G 9/1027; B32B 5/02; B32B 27/12; B32B 27/40; B32B 2274/00; B32B 2307/7242; B32B 2479/00

(57) ABSTRACT

An inflatable mattress is provided for allowing a user to temporarily rest or sleep on a hard surface. The inflatable mattress has an inflatable main body adapted for a human body to lie thereon in a prone position. The inflatable mattress also has an inflatable pillow on the main body that is adapted for a human head to rest thereon. The inflatable mattress also has an air-intake valve to fill the mattress with air and an exhaust valve to release the air. When air has been exhausted from the mattress, the mattress may be folded and/or rolled up into a compact size for storage.

### BACKGROUND

The present inventions relate generally to mattresses for a human to rest upon, and more particularly, to an inflatable mattress suitable for traveling.

Although people most commonly sleep or rest in their own permanent bed, which is usually constructed to have a semi-rigid structure with metal springs and an outer fabric covering, there are many occasions when a person is away from their home or motel without having access to a conventional bed for sleeping or resting. One example where a person may desire to rest or sleep in a prone position without having access to a conventional bed is during travel. This may occur, for example, during plane travel during a layover or as a result of an airplane delay or canceled flight. Camping is another example where a person may wish to rest or sleep in a prone position without having access to a conventional bed.

While many alternative resting solutions exist for such occasions, the current alternatives have many disadvantages. One solution which may be used is a conventional sleeping bag. However, sleeping bags are bulky and are usually designed to provide the user with warmth more than cushioning against hard floor surfaces. Foam mats may also be used, but again, foam mats are bulky. Cots may also be used and cots do provide improved cushioning since they raise the user off the hard floor surface like a conventional bed. However, cots are quite heavy and especially bulky. A blanket may also be used between a person's body and the hard floor surface, but most blankets provide minimal cushioning and are bulky like a sleeping bag.

Another solution that is sometimes used is an air mattress. However, current air mattresses have many disadvantages that prevent them from being used more widely for temporary resting or sleeping situations. Therefore, the present application is directed to improvements in air mattresses to make them more desirable and convenient for temporary resting or sleeping in a variety of locations away from a person's home or a motel.

### SUMMARY

An inflatable mattress is described that can be inflated to allow a user to temporarily rest upon the mattress instead of having to rest on a hard floor surface. The inflatable mattress can also be deflated into a compact size for convenient storage. The inflatable mattress has a main body and a pillow thereon that are suitable for a human to lie thereon in a prone position. Air-intake and exhaust valves are also provided to inflate and deflate the main body and pillow. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1 is a perspective view of an inflatable mattress;

FIG. 2 is a top view of the inflatable mattress;

FIG. 3 is a top view of a fill port;

FIG. 4 is a side view of a top end of the inflatable mattress;

FIG. 5 is a plan view of an outer surface of the inflatable mattress;

FIG. 6 is a cross-sectional view of sealing membrane of the inflatable mattress;

FIG. 7 is a perspective view of an exhaust valve shown in an open configuration;

FIG. 8 is a perspective view of the exhaust valve in a partially closed configuration;

FIG. 9 is a top view of the exhaust valve in a fully closed configuration;

FIG. 10 is a perspective view of the inflatable mattress shown in a partially rolled-up configuration;

FIG. 11 is a perspective view of the inflatable mattress folded lengthwise and being rolled-up;

FIG. 12 is a side view of the inflatable mattress stored in a storage bag; and

FIG. 13 is a perspective of the inflatable mattress being stored in a carry-on suitcase.

### DETAILED DESCRIPTION

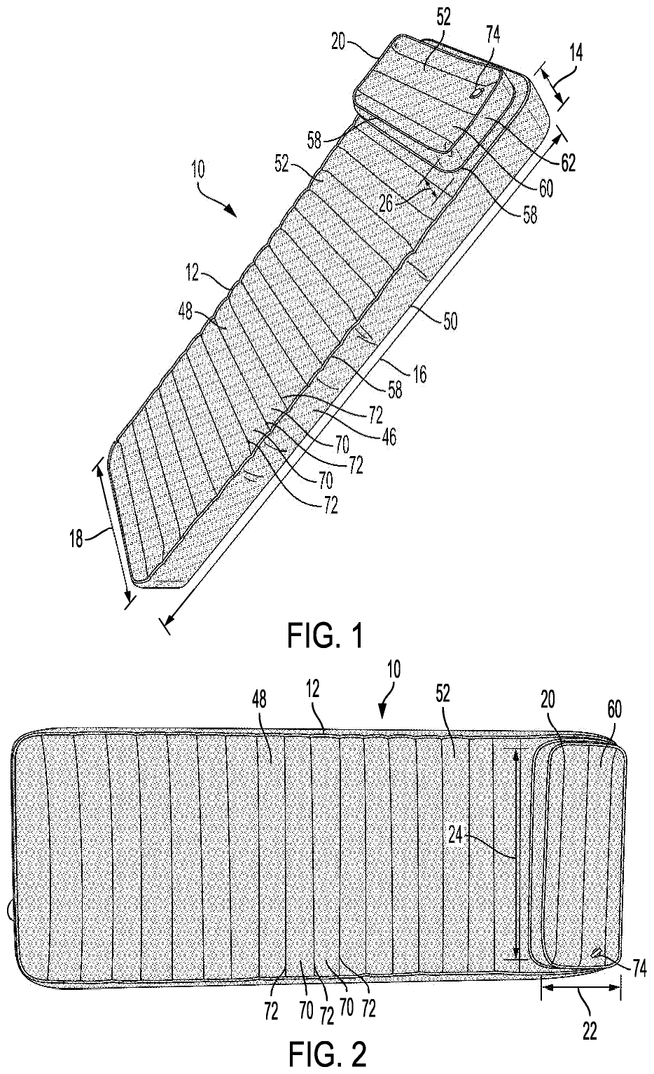

Referring now to the figures, and particularly FIGS. 1-2, a portable inflatable mattress 10 is shown. As shown, the inflatable mattress 10 is preferably rectangular and sized to fit an average human body lying on the mattress 10 in a prone position. The thickness 14 of the main body 12 is preferably relatively thin in order to maintain a compact size, especially when the mattress 10 is packed for storage. Thus, the dimensions of the main body 12 of the mattress 10 preferably has a length 16 that is longer than the width 18 and a thickness 14 that is thinner than the width 18.

The mattress 10 preferably also has an inflatable pillow body 20 permanently attached to the main body 12 of the mattress 10. The length 22 of the pillow 20 running along the length 16 of the main body 12 is substantially shorter than the length 16 of the main body 12, and is preferably less than a quarter as long as the main body 12. The width 24 of the pillow 20 running along the width 18 of the main body 12 may have a similar width 18 as the main body 12 or may have a width 18 that is somewhat less than the main body 12. The pillow 20 is preferably sized to fit a human head lying thereon. Thus, the dimensions of the pillow 20 preferably has a length 22 that is shorter than the width 24 and a thickness 26 that is thinner than the length 22. Because the pillow 20 is intended for a human head to rest thereon while the human is lying on the main body 12, it is preferable for the pillow 20 to be located adjacent one end of the main body 12 along its length 16.

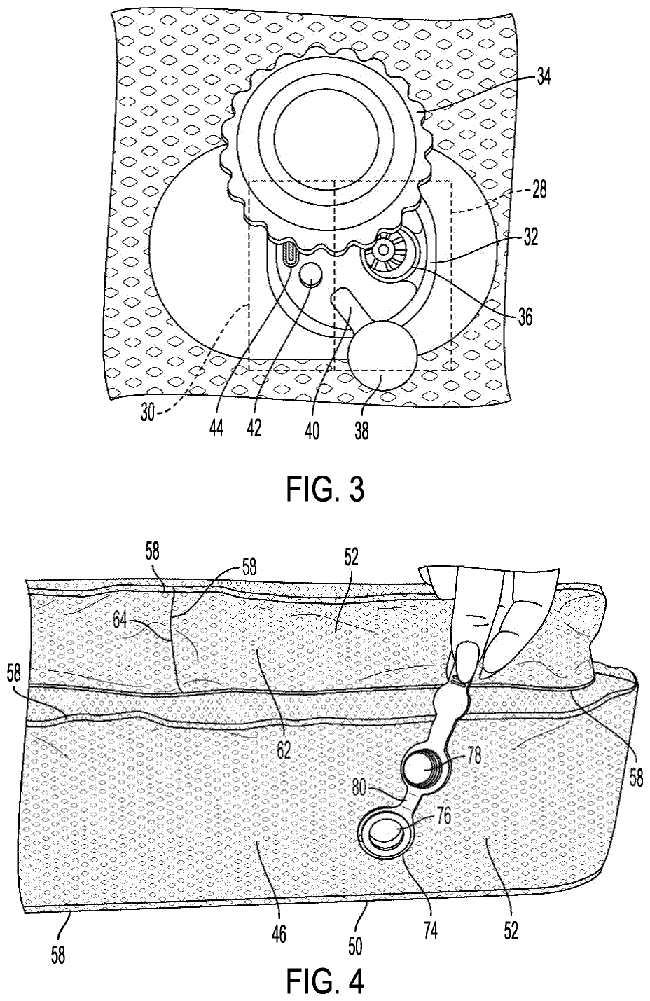

Turning to FIG. 3, the mattress 10 is preferably inflated with a pump 28, and particularly, with an electrical air pump 28. In order to make use of the mattress 10 as convenient as possible, the air pump 28 may be permanently attached to the mattress 10 and may be powered with one or more batteries 30 so that an electrical outlet is not needed to inflate the mattress 10 with the pump 28. Even more preferably, the pump 28 and batteries 30 may be located inside of the mattress 10 itself. That is, the electrical air pump 28 and battery 30 may be inside of the air cavity within the main body 12 or the pillow 20. As such, it is most preferable for the battery 30 to be a rechargeable battery 30, like a lithium-ion battery 30, which is non-replaceable.

In order to make use of the mattress 10 especially convenient, the mattress 10 may be provided with an air-intake port 32 as shown in FIG. 3. The air-intake port 32 preferably has a removable cap 34 that covers the port 32. If desired, the removable cap 34 may be loosely connected to the port 32 to prevent the cap 34 from being lost. An air-intake valve 36 which permits air to fill the mattress 10 may be located within the port 32. The valve 36 preferably has a check-valve therein, such that air may flow into the interior of the mattress 10 through the valve 36 but the valve 36 prevents air from flowing back out through the valve 36. As described, it is also preferable for an electrical air pump 28 to be provided which is connected to the valve 36 so that when the pump 28 is on, air is drawn into the mattress 10 through the valve 36 to inflate the mattress 10.

The air-intake port 32 may also have a plug 38 therein that is insertable into the air-intake valve 36 after the mattress 10 is inflated to ensure that air does not leak out through the valve 36. The plug 38 is preferably loosely connected 4 to the port 32 to prevent the plug 38 from being lost, and in the embodiment shown in FIG. 3, the plug 38 may be rotated 40 in order to be inserted into the valve 36. The port 32 also preferably has a switch 42, such as a button 42, therein which controls operation of the air pump 28. Thus, in the preferred embodiment, the button 42 may be pressed to turn on the pump 28 to inflate the mattress 10, and when the button 42 is released, the pump 28 is turned off. A charge port 44 is also preferably included within the air-intake port 32 to charge the battery 30 that powers the pump 28. Therefore, in the most preferred embodiment as shown FIG. 3, the removable cap 34 of the air-intake port 32 may cover the air-intake valve 36, the plug 38, the pump power switch 42 and the charge port 44. Further, the electrical air pump 28 and the battery 30 may be attached to the air-intake port 32 on the inside of the mattress 10.

Although it is possible for the main body 12 and the pillow 20 to have separate air cavities, in the preferred embodiment the main body 12 and the pillow 20 are in fluid communication with each other such that the main body 12 and the pillow 20 contain a single air cavity therein. Thus, in this arrangement, a single intake port 32 may be provided to inflate the mattress 10. Preferably, the air-intake port 32 is located on one of the sides 46 of the main body 12 so that the port 32 does not interfere with use of the top 48 or bottom 50 of the main body 12 or with the pillow 20. In the present embodiment, as shown in FIG. 2, it may be desirable to locate the air-intake port 32 on the end of the main body 12 (on the side 46 thereof) opposite from the pillow 20.

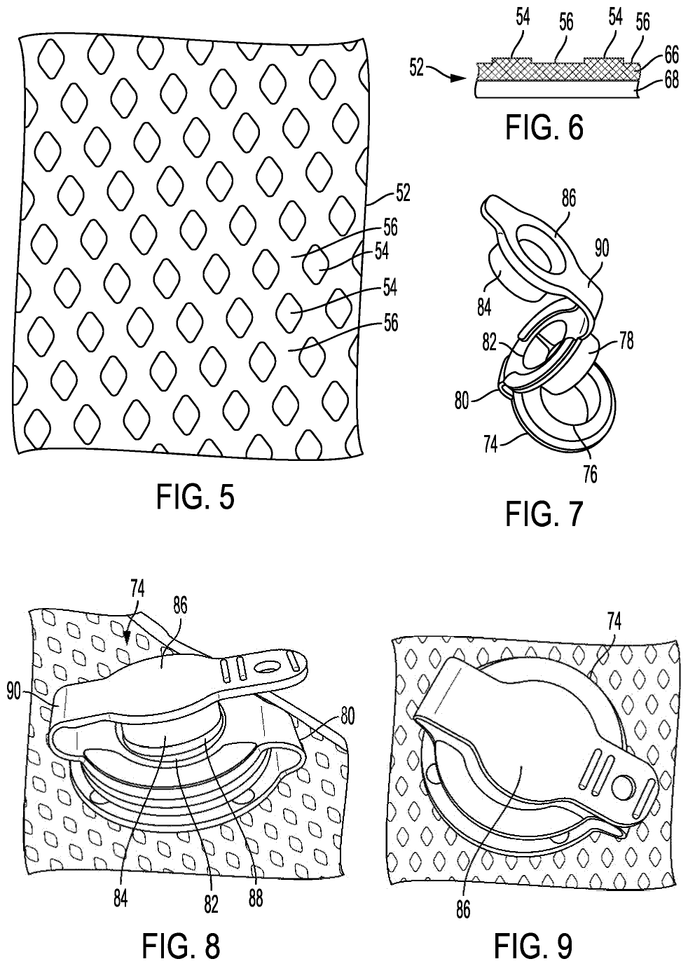

Turning to FIGS. 4-6, the material of the main body 12 and the pillow 20 which encloses the air cavit(ies) therein must be made of a sealing membrane 52 that is air impermeable to allow the mattress 10 to remain inflated without leaking air. Unlike many conventional inflatable mattresses, the preferred embodiment of the mattress 10 is not made of molded plastic. Instead, the exterior surfaces of the main body 12 and the pillow 20 are preferably made of a fabric material 52 that is air impermeable. For example, the exterior surfaces may be made of a woven nylon material. Alternatively, an artificial suede material may be desirable. In the most preferred embodiment, the exterior surfaces of the main body 12 and the pillow 20 do not have smooth surfaces, but instead, may be textured with a pattern of fabric protuberances 54 raised up from a fabric base surface 56. For example, as shown in FIG. 5, the raised protuberances 54 may form a diamond pattern on the outer surfaces of the mattress 10.

Unlike a molded plastic inflatable mattress, it is preferred for the main body 12 and pillow 20 to be formed from multiple sheets of sealing membranes 52 that are adhered together at the edges thereof to form seams 58. For example, seams 58 may exist between the top 48 and the sides 46 of the main body 12; between the bottom 50 and the sides 46 of the main body 12; between the top 60 and the sides 62 of the pillow 20; between the top 48 of the main body 12 and the sides 62 of the pillow 20; and vertically between edges 64 of the sides 46, 62 of the main body 12 and the pillow 20. The seams 58 are preferably formed without the use of sewing threads as this could lead to air leaks. Thus, the seams 58 are preferably formed by adhering the edges together with heat bonding or with an adhesive.

In a preferred embodiment, the sealing membranes 52 of the mattress 10 may be made of thermoplastic polyurethane. As shown in FIG. 6, this may be done with an outer fabric layer 66 (that may not be air impermeable) and an inner layer 68 of thermoplastic polyurethane that is air impermeable. The two layers 66, 68 are preferably bonded together so that the two layer 66, 68 behave as a single layer. As shown in FIGS. 1-2, the top surfaces 48, 60 of the main body 12 and the pillow 20 and also the bottom 50 of the main body 12 may also have an inflated corrugated structure. Thus, these surfaces 48, 50, 60 may have inflatable ridges 70 and interposed recesses 72 that extend across the widths 18, 24 of the main body 12 and the pillow 20.

Turning to FIGS. 4 and 7-9, the mattress 10 may also have an exhaust valve 74 to allow air to be released from the mattress 10 in order to collapse the mattress 10 for storage. In embodiments where the mattress 10 has a single interior air cavity, it may be sufficient for the mattress 10 to have only one exhaust valve 74. However, even where the mattress 10 has a single air cavity, it may be desirable to have multiple exhaust valves 74 so that air can be exhausted from the mattress 10 at a faster rate to make storing the mattress 10 faster. Some examples of where the exhaust valve 74 may be located include on the side 46 of the main body 12, and particularly on the end adjacent the pillow 20 (FIG. 4), and on the top surface 60 of the pillow 20 in a corner thereof (FIG. 2), although exhaust valves 74 may be located elsewhere as well. As shown in FIG. 4, the exhaust valve 74 has a hole 76 passing through the sealing membrane 52 to allow air inside the mattress 10 to escape out of the mattress 10 when the hole 76 is open. The exhaust valve 74 may also have a plug 78 that can be inserted into the hole 76 to prevent airflow through the hole 76.

Preferably, the plug 78 may be loosely connected to the hole 76, for example with an integral strap 80, in order to prevent the plug 78 from being lost. The back side of the plug 78 may also have an opening 82 extending into the back of the plug 78 (but does not extend through the plug 78 side). This opening 82 in the back side of the plug 78 may be used to insert the protrusion 84 of a locking member 86 into the opening 82 to further secure the plug 78 in the hole 76 of the mattress 10. For example, the locking member 86 may have a circumferential rib 88 extending thereabout that presses outward against the opening 82 in the back of the plug 78 to lock the plug 78 into the opening 82. Preferably, the locking member 86 may be loosely connected to the plug 78, for example with an integral strap 90, in order to prevent the locking member 86 from being lost.

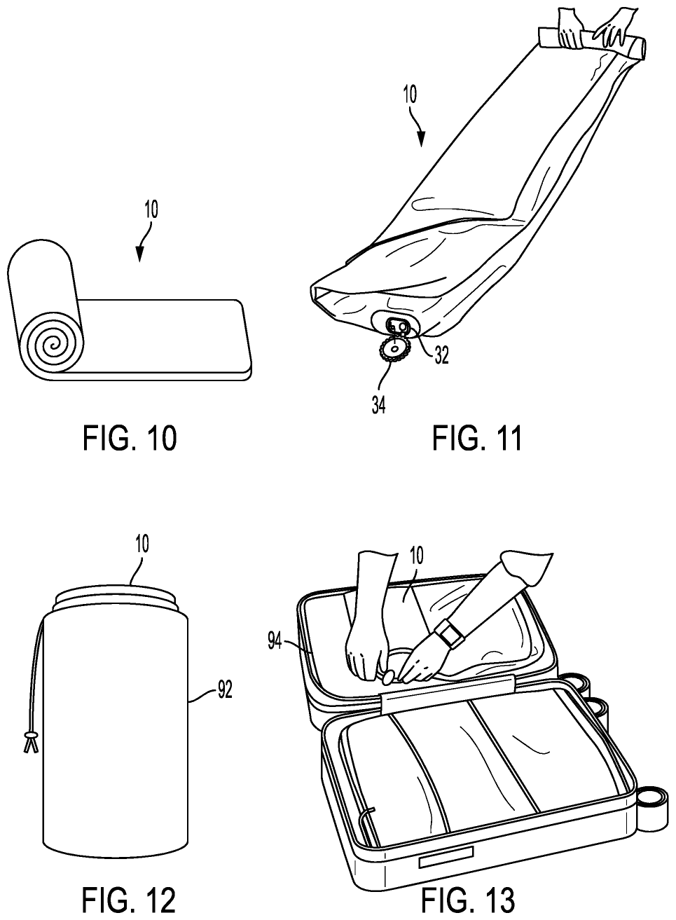

Turning to FIGS. 10-13, after the mattress 10 has been collapsed by opening the exhaust valve 74 and allowing the air inside the mattress 10 to be released, the main body 12 and pillow 20 of the mattress 10 collapse into a flattened shape. This allows the mattress 10 to be rolled up and/or folded. For example, in FIG. 11, the mattress 10 may be folded in half, lengthwise and then rolled up. The mattress 10 may then be placed inside a storage bag 92 if desired as shown in FIG. 12. Particularly desirable, when the mattress 10 has been collapsed, it may be stored within a standard airline carry-on suitcase 94 as shown in FIG. 13. This allows the user to conveniently keep the mattress 10 with them during airline travel so that the mattress 10 may be used during long layovers at an airport or when a flight has been delayed or canceled.

While preferred embodiments of the inventions have been described, it should be understood that the inventions are not so limited, and modifications may be made without departing from the inventions herein. While each embodiment described herein may refer only to certain features and may not specifically refer to every feature described with respect to other embodiments, it should be recognized that the features described herein are interchangeable unless described otherwise, even where no reference is made to a specific feature. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. An inflatable mattress, comprising:
a first inflatable body having a length longer than a width of the first inflatable body and having a thickness thinner than the width of the first inflatable body;
a second inflatable body having a length shorter than a width of the second inflatable body and having a thickness thinner than the length of the second inflatable body;
the first inflatable body being sized for a human body to lie upon and the second inflatable body being sized for a human head to lie upon, the width of the second inflatable body being disposed along the width of the first inflatable body and being disposed adjacent one end of the length of the first inflatable body;
one or more air-intake valves permitting air to fill the first and second inflatable bodies; and
one or more exhaust valves permitting air within the first and second inflatable bodies to be released from the first and second inflatable bodies.

2. The inflatable mattress according to claim 1, wherein a top surface of the first inflatable body is corrugated with inflatable ridges extending along the width of the first inflatable body, the inflatable ridges being interposed with recesses extending between the inflatable ridges and extending along the width of the first inflatable body.

3. The inflatable mattress according to claim 1, wherein a top surface of the second inflatable body is corrugated with inflatable ridges extending along the width of the second inflatable body, the inflatable ridges being interposed with recesses extending between the inflatable ridges and extending along the width of the second inflatable body.

4. The inflatable mattress according to claim 1, wherein a bottom surface of the first inflatable body is corrugated with inflatable ridges extending along the width of the first inflatable body, the inflatable ridges being interposed with recesses extending between the inflatable ridges and extending along the width of the first inflatable body.

5. The inflatable mattress according to claim 1, wherein the first and second inflatable bodies are in fluid communication with each other, and consisting of a single air-intake valve permitting air to fill both of the first and second inflatable bodies.

6. The inflatable mattress according to claim 1, wherein a fabric is disposed on external surfaces of the first and second body.

7. The inflatable mattress according to claim 6, wherein the fabric comprises a pattern of protuberances raised from a base surface.

8. The inflatable mattress according to claim 1, wherein the first and second inflatable bodies are formed from multiple sheets of sealing membranes adhered together at edges thereof, the adhered edges being disposed between at least a top and sides of the first inflatable body, a bottom and the sides of the first inflatable body, and a top and sides of the second inflatable body.

9. The inflatable mattress according to claim 1, wherein the first and second inflatable bodies are formed from one or more sealing membranes comprising thermoplastic polyurethane.

10. The inflatable mattress according to claim 1, wherein the first and second inflatable bodies are formed from one or more sealing membranes comprising an air impermeable layer and a fabric layer bonded to the air impermeable layer, the air impermeable layer being exposed to an interior space of the first and second inflatable bodies and the fabric layer being disposed on external surfaces of the first and second inflatable bodies.

11. The inflatable mattress according to claim 10, wherein the air impermeable layer comprises thermoplastic polyurethane.

12. The inflatable mattress according to claim 1, wherein at least one of the one or more air-intake valves is disposed on a side of the first inflatable body along the thickness thereof.

13. The inflatable mattress according to claim 12, wherein the at least one of the one or more air-intake valves is disposed on an end of the first inflatable body.

14. The inflatable mattress according to claim 12, wherein the at least one of the one or more air-intake valves is disposed on an end of the first inflatable body opposite from the second inflatable body.

15. The inflatable mattress according to claim 1, further comprising an electrical air pump connected to at least one of the one or more air-intake valves to draw air through the at least one of the one or more air-intake valves to inflate the first and/or second inflatable bodies.

16. The inflatable mattress according to claim 15, further comprising an air-intake port comprising the at least one of the one or more air-intake valves, a switch to turn the electrical air pump on and off, and a charge port to charge a battery supplying the electrical air pump with power.

17. The inflatable mattress according to claim 16, further comprising a removable cap covering the at least one of the one or more air-intake valves, the switch, and the charge port.

18. The inflatable mattress according to claim 17, further comprising a plug insertable into the at least one of the one or more air-intake valves to prevent air flow through the at least one of the one or more air-intake valves, the plug being covered by the removable cap.

19. The inflatable mattress according to claim 15, wherein the electrical air pump is disposed within the first or second inflatable bodies, and further comprising a battery supplying the electrical air pump with power, the battery being a rechargeable, non-replaceable battery disposed within the first or second inflatable bodies.

20. The inflatable mattress according to claim 1, wherein at least one of the one or more exhaust valves comprises a hole extending into the first or second inflatable bodies to permit air to be released, a plug loosely connected to the hole to prevent loss of the plug, the plug comprising a first side being insertable into the hole to prevent air flow through the hole and a second side comprising an opening extending longitudinally through the backside of the plug, and locking member loosely connected to the plug to prevent loss of the locking member, the locking member comprising a protrusion insertable into the opening of the plug to lock the plug into the hole.
